(19) United States
(12) Patent Application Publication
(10) Pub. No.: US 2019/0067866 A1
(43) Pub. Date: Feb. 28, 2019

(54) HOUSING PART WITH AN INSPECTION POINT FOR TIGHTNESS INSPECTION

(71) Applicant: Phoenix Contact E-Mobility GmbH, Schieder-Schwalenberg (DE)

(72) Inventors: Dirk Moseke, Hoexter-Luechtringen (DE); Ralf Feldner, Detmold (DE)

(21) Appl. No.: 16/070,552

(22) PCT Filed: Jan. 17, 2017
(86) PCT No.: PCT/EP2017/050837

§ 371 Date: Jul. 17, 2018

(30) Foreign Application Priority Data
Jan. 19, 2016 (DE) 10 2016 100 817.6

(51) Int. Cl. H01R 13/52; H01R 13/46

(52) U.S. Cl. CPC H01R 13/52; H01R 13/465

(57) ABSTRACT

The invention relates to a housing part (14) for an electrical or electronic device, in particular for an electrical plug connector part (1), which comprises a moisture-tight chamber (146) surrounded by a wall (144). The housing part (14) has an inspection point having an opening (141) that opens into the moisture-tight chamber (146) and a membrane element (143) that covers the opening (141) and that can be pierced by a hollow needle (61) of an inspection device (6). In this way, a housing part that enables a tightness inspection in a simple manner is provided.

### CROSS-REFERENCE TO PRIOR APPLICATIONS

This application is a U.S. National Stage Application under 35 U.S.C. § 371 of International Application No. PCT/EP2017/050837 filed on Jan. 17, 2017, and claims benefit to German Patent Application No. DE 10 2016 100 817.6 filed on Jan. 19, 2016. The International Application was published in German on Jul. 27, 2017, as WO 2017/125363 A1 under PCT Article 21(2).

### FIELD

The present invention relates to a housing part for an electrical or electronic device, particularly for an electrical plug connector part.

### BACKGROUND

A housing part for an electrical or electronic device, particularly for an electrical plug connector part may have a moisture-tight chamber surrounded by a wall.

For example, on a plug connector part designed as a charging plug or as a charging socket for a charging system for charging an electric vehicle, there can be, within a housing, a moisture-tight chamber, within which electrical contacts (for example) of the plug connector part are contacted by wires of an electrical line. The moisture-tight chamber can be surrounded by housing walls such that moisture penetration into this chamber is prevented; and thus, exposed electric contact points within the chamber cannot come into contact with moisture.

Such a moisture-tight chamber can also be present in other electrical or electronic devices, for example in an electronic device to be arranged on a mounting rail of an industrial system or similar. Within such a moisture-tight chamber, electrical or electronic components, for example circuitry on a circuit board or similar, can be arranged.

Generally, there is a need to inspect the tightness of such a chamber within a housing after completing installation of the electrical or electronic device. For example, it may be desirable to inspect a plug connector part, such as a charging plug or charging socket, after installation for tightness to ensure that, within the housing of the plug connector part, arranged electrical components cannot come into contact with moisture. To this end, a pressure test is normally conducted, within the scope of which a fluid, for example air, is introduced into the moisture-tight chamber to create an over-pressure within the moisture-tight chamber and to check how the pressure changes over a period of time. Using the pressure change, one can draw conclusions about the tightness of the chamber.

Such pressure-testing is time-consuming and conventionally requires a special testing device. In particular, access to the moisture-tight chamber to perform a pressure test within the moisture-tight chamber is only possible with great effort.

In a method known from DE 10 2007 040 864 A1 for testing an electrical connection device for tightness of at least one component of the connection device, the connection device to be tested is affixed to a test device and a liquid is introduced in a chamber of the test device in such a manner that the device to be tested comes in contact with the liquid. If penetration of the liquid in the device to be tested is detected, this points to a lack of tightness of the device.

In regard to a device known from DE 295 13 684 U1 for testing the tightness of a plug housing, one can introduce compressed air via a plug holder into the plug housing to check by means of a pressure change whether there is a sealing component possibly missing on the plug housing.

In a method known from U.S. Pat. No. 5,596,138 for testing the tightness on a plug connector, compressed air is supplied via an opening to a plug connector housing to measure the pressure within the plug connector housing.

### SUMMARY

An embodiment of the present invention provides a housing part for an electrical or electronic device that includes a moisture-tight chamber surrounded by a wall; an inspection point having an opening, which opens into the moisture-tight chamber; and a membrane element configured to be pierced by a hollow needle of a test device.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a schematic view of an electric vehicle, which can be charged via a charging system;

FIG. 2 is a schematic view of a plug connector part in the form of a charging socket;

FIG. 3 is a perspective view of an embodiment of a plug connector part in the form of a charging socket;

FIG. 4 is a side view of the plug connector part;

FIG. 5 is a front view of the plug connector part;

FIG. 6A is a partial sectional view of a housing part of the plug connector part;

FIG. 6B is another partial sectional view of the housing part;

FIG. 7A is a plan view of the housing part, prior to attaching a test device;

FIG. 7B is a side view of the arrangement of FIG. 7A;

FIG. 7C is a sectional view through the arrangement according to FIG. 7B;

FIG. 8A is a plan view of the housing part with a test device attached;

FIG. 8B is a side view of the arrangement of FIG. 8A;

FIG. 8C a sectional view through the arrangement according to FIG. 8B; and

FIG. 9 a schematic sectional view through the plug connector part, showing a moisture-tight chamber inside a housing part of the plug connector part.

### DETAILED DESCRIPTION

The inventors have recognized a need to simplify a pressure test on an electrical or electronic device.

The present invention provides a housing part, a plug connector part as well as a method for testing the tightness of a moisture-tight chamber of a housing part, which allows one to check tightness in a simple manner.

In embodiments of the invention, the housing part has an inspection point with an opening that opens into the moisture-tight chamber and a membrane element covering the opening and which is able to be pierced by a hollow needle of a test device.

In this way, there is provided on the housing part an inspection point, which allows access to the moisture-tight chamber for the purpose of checking the tightness of the moisture-tight chamber. The inspection point includes an opening, which opens into the moisture-tight chamber and is covered by a membrane element, which is attached to the opening and thereby seals the opening in a moisture-tight manner in a normal operating state. The membrane element can be pierced by a hollow needle of a testing device so that, via the hollow needle, a fluid can be introduced into the moisture-tight chamber or suctioned out of the moisture-tight chamber to conduct a tightness test using the pressure set in the moisture-tight chamber.

The membrane element is preferably self-closing. It is to be hereby understood that the membrane element can be pierced by the hollow needle and will reclose itself after the hollow needle is removed. Upon completion of the tightness inspection, the membrane element thus seals the opening to the moisture-tight chamber so that the tightness of the moisture-tight chamber is not impaired by the inspection point.

The membrane element is preferably manufactured of an elastic material, for example an elastomer. Such membrane elements are known for example from medical technology, where they are used for sealing a port for a liquid container, for example a flexible pouch.

Such a housing part can, for example, be a component of a plug connector part. Such a plug connector part can, for example, be designed as a charging plug or as a charging socket of a charging system for charging an electric vehicle. A charging plug can be arranged on a charging cable for example, while a charging socket can be mounted on a vehicle for example. For charging the electric vehicle, the charging plug can be inserted into the charging socket to create in this way an electrical connection between a charging station and the electric vehicle and to transmit charging current between the charging station and the electric vehicle.

Such a plug connector part has, for example, arranged on the housing parts, a plug section, to which are arranged one or more electrical contact elements for electrically contacting a mating connector part. By means of the plug section, the plug connector part can be made to engage in a plugging manner with the mating connector part so that the electrical contact elements arranged on the plug section electrically contact the assigned mating contact elements of the mating connector part, and thus an electrical connection is created between the plug connector part and the mating connector part.

Given such a plug connector part, the moisture-tight chamber can be used, for example, to electrically connect one or more contact elements to a line connected to the plug connector part. To this end, the contact elements protrude, for example, into the moisture-tight chamber. In addition, a connection point can be arranged on a wall of the moisture-tight chamber for connecting an electrical line, so that the electrical line can be led into the moisture-tight chamber via the connecting point. Within the moisture-tight chamber, for example, one or more electrical contacting devices may be arranged (e.g., in the form of terminals) which are used to electrically connect the one or more contact elements with one or more cable wires of the line. Due to the fact that the contacting devices are arranged inside the moisture-tight chamber, the contacting devices cannot come into contact with moisture when the plug connector part is used at a later point in time, so that the operational safety of the plug connector part is assured.

For a plug connector part, it may be provided in one embodiment that moisture entering into the region of the plug section of the plug connector part is discharged via an outlet port to prevent moisture from accumulating in the region of the plug section. In an advantageous embodiment, this outlet port can be aligned with the opening of the inspection point in such a manner that, for the purpose of the tightness inspection, the hollow needle is inserted via the outlet port and can pierce the membrane element at the opening of the inspection point. The inspection point is thus accessible from the outside via the outlet port, by the hollow needle being inserted through the outlet port and piercing the membrane element at the opening. By compressed air, for example, then being introduced into the moisture-tight chamber via the hollow needle, prior to putting the plug connector into service, one can check the tightness of the plug connector part in a simple, reliable manner.

Due to the fact that an easily accessible inspection point is created on the housing part, a tightness check of the plug connector part is possible in a simple, automatable manner. Via the inspection point, a hollow needle can be simply inserted into the moisture chamber to supply compressed air in this manner or, if applicable, to create a vacuum within the moisture-tight chamber to test the tightness of the moisture-tight chamber by means of such pressure testing. Via the inspection point, one can perform such a tightness check without particularly complex implements, wherein after the tightness check is completed, the hollow needle can be simply removed from the inspection point and no particular measures are required to seal the inspection point after the completed tightness check, especially if the membrane element is self-closing.

In a method for testing the tightness of a housing part, which has a moisture-tight chamber surrounded by a wall: a membrane element is pierced with a hollow needle, which covers an opening that opens into the moisture-tight chamber of an inspection point of the housing part; and a fluid is introduced into or suctioned out of the moisture-tight chamber of the plug connector part via the hollow needle.

By introducing or suctioning the fluid, a pressure can be set inside the moisture-tight chamber of the housing part to allow one to draw conclusions about the tightness of the moisture-tight chamber of the housing part by means of the pressure and for example a change of the pressure over time.

The method is easily automatable. For example, an electromechanical positioning device can be used, which automatically positions the hollow needle relative to the inspection point of the housing part and brings the hollow needle to pierce the membrane element at the inspection point. Such a positioning device can be designed, for example, as a robot, as part of a production line for manufacturing a plug connector part.

The hollow needle can be connected, for example, to a tube and via the tube to a control device. Via the tube, a fluid can be introduced into the moisture-tight chamber or suctioned out of the moisture-tight chamber to create an overpressure or negative pressure within the moisture-tight chamber. By means of the control device, one can hereby set a specified overpressure (by supplying a fluid such as compressed air) or a negative pressure (by suctioning air out of the moisture-tight chamber). The control device can then measure via the hollow needle how pressure changes over time to then draw conclusions about the tightness of the moisture-tight chamber by means of the pressure change.

For example, a repeated pressure measurement within a specified period of time can be performed. A first pressure measurement can be taken at a first point in time and a second pressure measurement can be taken after a specified time after the first pressure measurement. Using the pressure change, one can draw conclusions about the tightness of the moisture-tight chamber. This tightness test can be performed in a fully automated manner by means of the control device, wherein permissible limits may be specified for a pressure change (e.g., by means of the protection-type characterized by so-called IP codes, which indicates the suitability of electrical equipment for various ambient conditions).

After completing the tightness check, the hollow needle can be pulled out of the membrane element, whereupon the membrane element preferably closes by itself; and thus, an additional sealing of the inspection point is not required after the tightness check is performed.

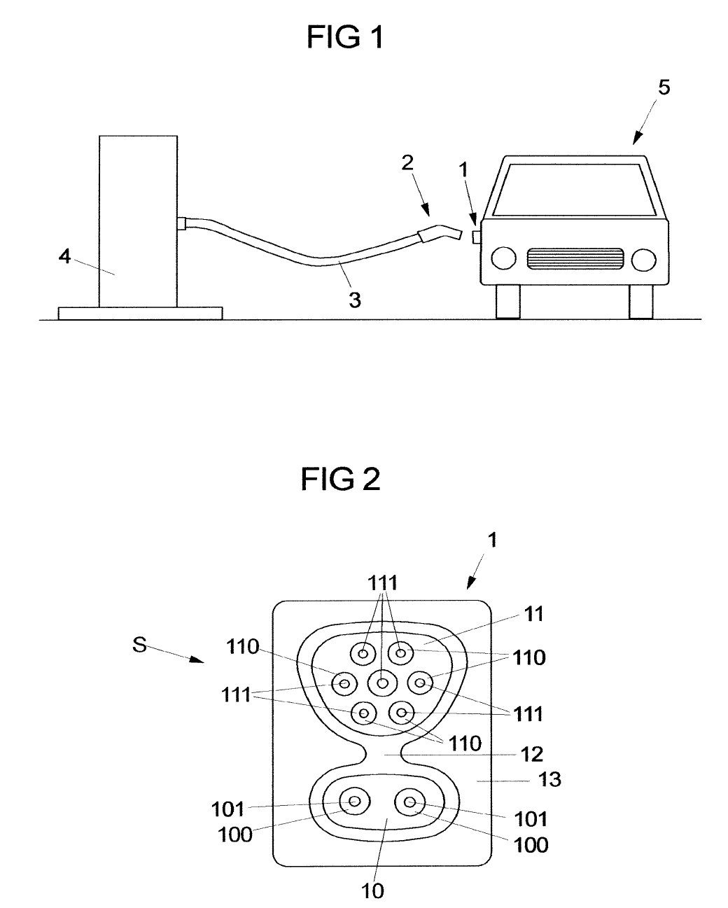

FIG. 1 shows in a schematic view, a charging system as it is used for charging an electrically powered vehicle 5, called an electric vehicle for short. Electric vehicle 5 has a plug connector part 1 in the form of a charging socket, into which an assigned mating connector part 2 in the form of a charging plug on a charging cable 3 can be inserted. Charging cable 3 is electrically connected to a charging station 4 so that by inserting mating connector part 2 into plug connector part 1, an electrical connection can be created between charging station 4 and electric vehicle 5, and charging current can be transmitted between charging station 4 and electric vehicle 5 for charging the batteries of electric vehicle 5.

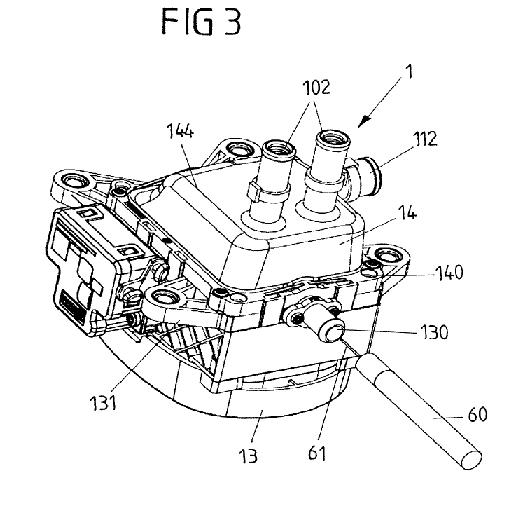

A schematic view of plug interface S of a plug connector part 1 in the form of a charging socket is depicted in FIG. 2. In contrast, FIGS. 3 to 5 depict views of an actual example embodiment of such a plug connector part 1 in the form of a charging socket.

Plug connector part 1 provides for two different plug sections 10, 11, which each have a plurality of plug-in openings 100, 110 with contact elements 101, 111 arranged inside. A first, lower plug section 10 hereby has two contact elements 101 and serves to transmit a charging current in the form of a direct current. A second, upper plug section 11 has, in contrast, five load contacts 111 and two signal contacts 111 and serves to transmit a charging current in the form of a (multiphase) alternating current.

Plug sections 10, 11 are designed as raised sections and are separated by an intermediate chamber 12 from a screening part 13. In the intermediate chamber 13, there may be a section of the assigned mating connector part 2 inserted, wherein provided on mating connector part 2 there are plug sections for inserting into assigned insertion openings 100, 110 for electrically contacting contact elements 101, 111, so that by inserting mating connection parts 2 in the form of the charging plug into plug connector part 1 in the form of the charging socket, an electrical contact can be created between plug connector parts 1, 2.

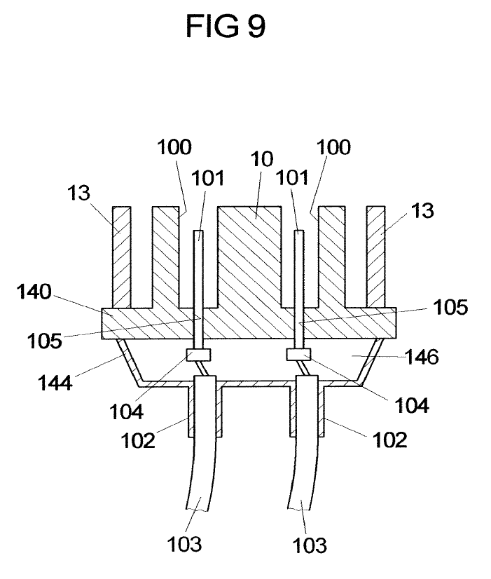

Plug connector part 1 of the embodiment according to FIGS. 3 to 5 has a housing part 14, which is connected via a flange 140 to a flange 131 of screen part 13. Housing part 14 has a housing wall 144, within which a moisture-tight chamber 146 is formed, as is schematically depicted in FIG. 9.

On wall 144, there are arranged connection points 102, 112 for connecting electrical lines 103. Via connection points 102, 112, lines 103 can be led into moisture-tight chamber 146 so that line wires of lines 103 can be electrically contacted via contacting devices 104, for example in the form of terminals, with contact elements 101 penetrating into chamber 146, as is depicted in FIG. 9. The electrical connection between lines 103 and contact elements 101 thus occurs within moisture-tight chamber 146, which is protected against moisture penetration and thus encloses contacting devices 104 in a moisture-tight manner.

Contact elements 101 protrude, as schematically shown in FIG. 9, into chamber 146, wherein contact elements 101 pass in the form of contact pins through openings 105 of flange 140 of housing part 14, and thus are led from front plug interface S to chamber 146. The passage between contact elements 101 and openings 105 is hereby moisture-tight, so that no moisture from the area of plug interface S can enter into chamber 146.

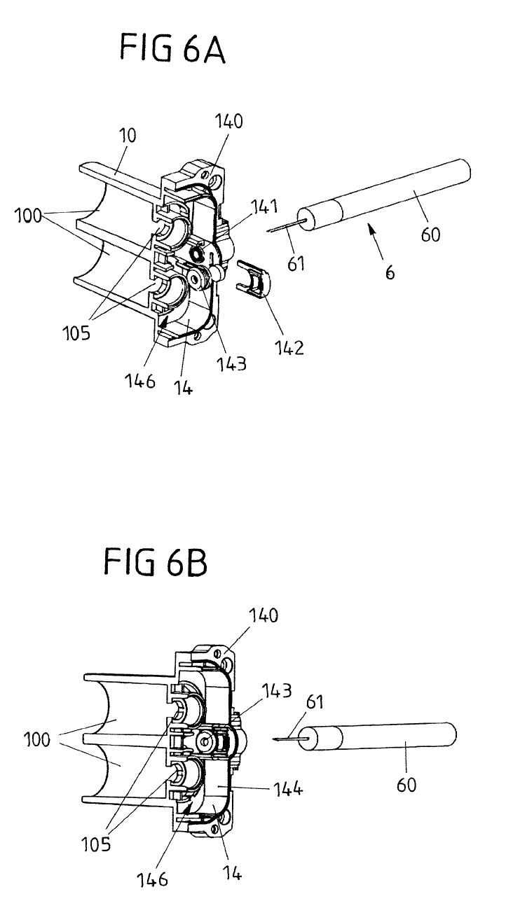

To ensure the functional readiness and the operational safety of plug connector part 1, it is necessary to check the tightness of moisture-tight chamber 146. To this end, there is provided on housing part 14 an inspection point, which is formed by an opening 141 (FIG. 6A), which is sealed by a membrane element 143 secured via an attachment element 142 to housing part 14. Membrane element 143 can be pierced by a hollow needle 61 of a testing device 6, so that, via the inspection point, a fluid, for example air, can be introduced into chamber 146 or suctioned out of chamber 146, to set a pressure inside chamber 146 and to check, for example by means of a change in pressure, whether moisture-tight chamber 146 meets the specified tightness requirements.

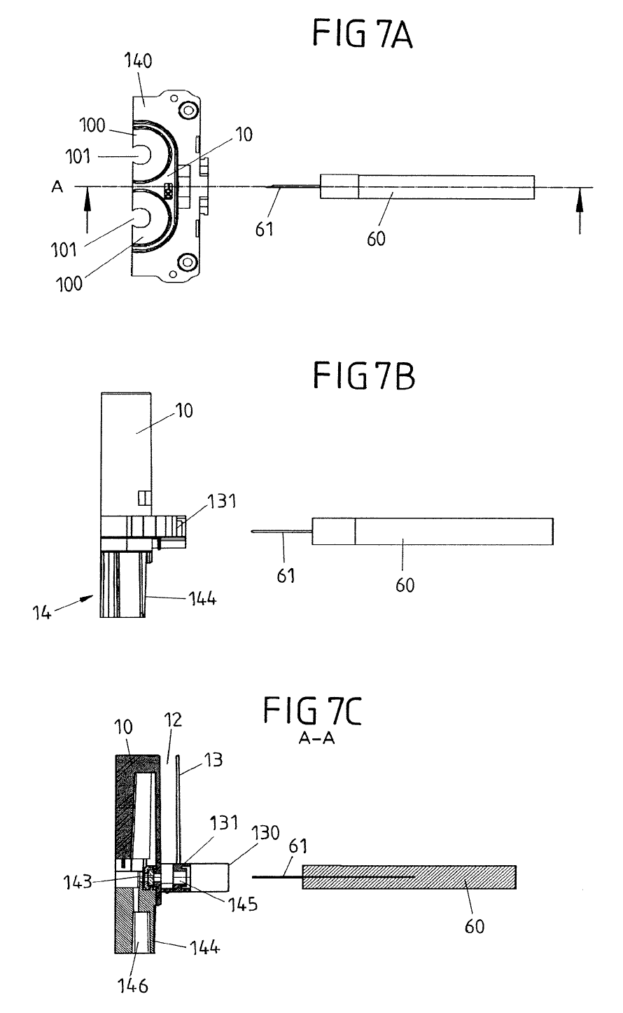

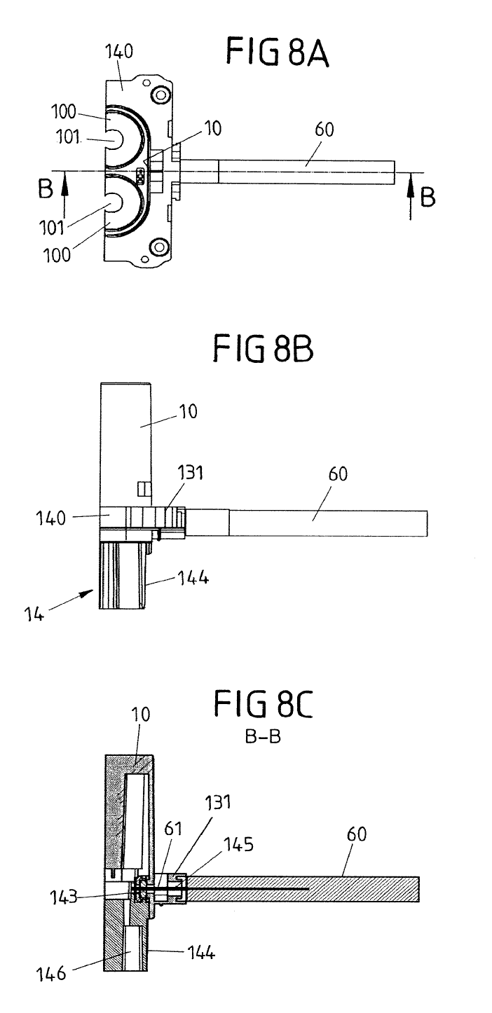

FIGS. 6A, 6B depict partial sectional views of housing part 14 in the region of the first, lower plug section 10 according to FIG. 2. FIGS. 7A to 7C and 8A to 8C also show housing part 14 prior to attaching hollowing needle 61 (FIGS. 7A to 7C) and with needle 61 attached (FIGS. 8A to 8C).

Membrane element 143 is manufactured as a self-closing membrane, for example out of an elastomer. Membrane element 143 can be pierced by hollow needle 61, so that with hollow needle 61 doing the piercing, hollow needle 61 penetrates into chamber 146, as one can see in FIG. 8C. With hollow needle 61 inserted, a tightness check of chamber 146 can be performed and after the tightness check is completed, hollow needle 61 can be pulled out of membrane element 143, whereupon membrane element 143 automatically closes again and thus special measures are not required for sealing the inspection point after a completed tightness check.

As one can see in FIG. 7C, the inspection point, including an opening 141 and membrane element 143, is aligned with an outlet port 130, which is affixed to plug connector part 1, to allow for a liquid to be discharged from intermediate chamber 12 between screen part 13 and plug sections 10, 11. At outlet ports 130, there can be connected a drain line for example so that via outlet ports 130, water can drain from intermediate chamber 12 and be conducted out of the region of plug connector part 1.

Because outlet port 130 is aligned with the inspection point, hollow needle 61 can be guided through outlet port 130 and inserted via an opening 145 in flange 140 into membrane element 143. Access to the inspection point from the outside is thus easily possible, wherein the concealed arrangement of the inspection point within plug connector part 1 also prevents unintentional access to the inspection point.

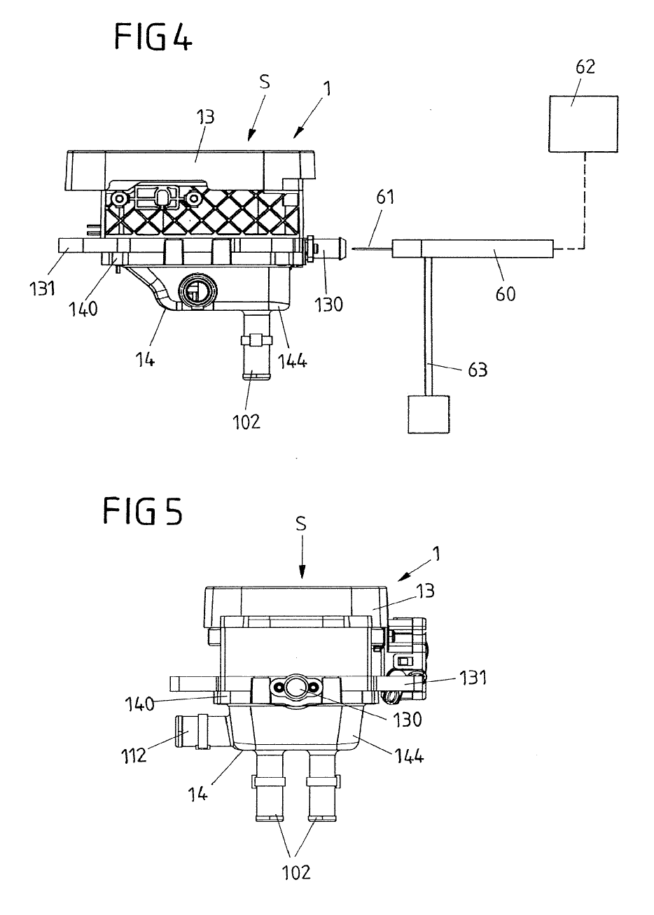

By means of the inspection point, a tightness check is possible in an easily automatable manner. For example, a hollow needle 61, which may be connected to a tube 60 and via tube 60 to a control device 62, for example via an electromechanical positioning device 63 (schematically depicted in FIG. 4), can be introduced into outlet port 130 and attached to the inspection point, by having membrane element 143 pierced by hollow needle 61. The additional tightness check can take place automatically, by having a fluid, for example compressed air, introduced into chamber 146 for example via control device 62, tube 60, and hollow needle 61 to set a specified pressure inside chamber 146. The pressure inside chamber 146 is now measured, and after a specified period, another pressure measurement is taken to determine by means of a change in pressure whether chamber 146 meets the specified tightness requirements, for example as specified according to an IP protection-type. Upon completion of the tightness check, hollow needle 61 can then be pulled off membrane element 143, which in turn can occur automatically via positioning device 63.

The concept underlying the invention is not limited to the precedingly described embodiments but can also be implemented in an entirely different manner.

In particular, an inspection point of the type described here can basically be provided for totally different types of electrical or electronic devices and is thus not limited to a plug connector part of the type described here. An inspection point of the type described here may be advantageous for all those devices, which have inside a housing a moisture-tight chamber with electric and/or electronic devices arranged inside, to make possible a tightness check for such devices in a simple and reliable manner.

As described in detail above, an embodiment of the invention provides a housing part (14) for an electrical or electronic device, in particular for an electrical plug connector part (1), which includes a moisture-tight chamber (146) surrounded by a wall (144). The housing part (14) has an inspection point having an opening (141) that opens into the moisture-tight chamber (146) and a membrane element (143) that covers the opening (141) and that can be pierced by a hollow needle (61) of an inspection device (6). In this way, a housing part that enables a tightness inspection in a simple manner is provided.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

Below is a list of references used in this specification:
1 plug connector part (charging socket)
10, 11 plug section
100, 110 insertion opening
101, 111 contact element
102, 112 connection point
103 connecting cable
104 contacting device
105 opening
12 intermediate chamber
13 screening part
130 outlet port
131 flange
14 housing part
140 flange
141 opening
142 fastening element
143 membrane element
144 wall (housing case)
145 opening
146 interior
2 mating connector part (charging plug)
3 charging cable
4 charging station
5 vehicle
6 test device
60 tube
61 hollow needle
62 control device
63 positioning device
S plug interface

1. A housing part for an electrical or electronic device, the housing part comprising:
a moisture-tight chamber surrounded by a wall;
an inspection point having an opening, which opens into the moisture-tight chamber; and
a membrane element configured to be pierced by a hollow needle of a test device.

2. The housing part according to claim 1, wherein the membrane element is self-closing.

3. The housing part according to claim 1, wherein the membrane element comprises an elastic material.

4. A plug connector part configured to engage in a plugging connection with a mating connector part, the plug connector part comprising:
a housing part according to claim 1;
a plug section arranged on the housing part; and
at least one electrical contact element arranged on the plug section for electrically contacting the mating connector part.

5. The plug connector part according to claim 4, wherein the at least one contact element projects into the moisture-tight chamber.

6. The plug connector part according to claim 4, wherein on the wall of the moisture-tight chamber, there is a connector arranged for connecting an electrical line.

7. The plug connector part according to claim 6, wherein inside the moisture-tight chamber, an electrical contacting device is arranged for electrically connecting the at least one contact element to the electrical line.

8. The plug connector part according to claim 4, wherein the opening is arranged in an aligning manner to an outlet port configured to drain moisture out of a section of the housing part in such a manner that the hollow needle is insertable through the outlet port for piercing the membrane element at the opening.

9. A method for checking a tightness of a housing part, which has a moisture-tight chamber surrounded by a wall, the method comprising:
piercing, with a hollow needle, a membrane element, which covers an opening, which opens into the moisture-tight chamber, of an inspection point of the housing part; and
introducing or suctioning a fluid in the moisture-tight chamber of the plug
connector part via the hollow needle.

10. The method according to claim 9, wherein the hollow needle is positioned relative to the housing part by a positioning device for piercing the membrane element.

11. The method according to claim 9,
wherein the hollow needle is connected via a tube to a control device, and
wherein a specified pressure is produced in the moisture-tight chamber for supplying or suctioning the fluid in the moisture-tight chamber, controlled by control device.

12. The method according to claim 11, wherein to check the tightness, the pressure in the moisture-tight chamber is monitored within a specified period.

13. The method according to claim 9, wherein the hollow needle is pulled out of the membrane element after the tightness check is completed.

14. The housing device according to claim 1 is for an electric plug connector part.

15. The housing device according to claim 3, wherein the elastic material is an elastomer.
